(19) United States
(12) Patent Application Publication
(10) Pub. No.: US 2005/0241098 A1
(43) Pub. Date: Nov. 3, 2005

(54) Window wiping device and wiper arm, especially for a motor vehicle

(76) Inventors: Michael Weiler, Chungchongbuk-Do (DE); Joachim Zimmer, Sasbach (DE)

Correspondence Address: MICHAEL BEST & FRIEDRICH, LLP, 100 E WISCONSIN AVENUE, MILWAUKEE, WI, 53202, US

(21) Appl. No.: 10/520,375

(22) PCT Filed: Feb. 26, 2003
(86) PCT No.: PCT/DE03/00616

§ 371 Date: Jan. 5, 2005

(30) Foreign Application Priority Data
Jul. 30, 2002 (DE) 102 34 613.5

(51) Int. Cl. B60S 1/34

(52) U.S. Cl. 15/250.34; 15/250.31; 15/250.351

(57) ABSTRACT

A windshield wiper device (10), in particular for a motor vehicle, is proposed which features a wiper shaft (28, 30) with a cone (34) on which a wiper arm (32) can be fastened, whereby a macroscopic structure is superimposed on the cone (34). In addition, a wiper arm (32), in particular for a windshield wiper device (10) featuring a fastening part (47) with an inner cone (37), which can be fastened on a cone (34), whereby a macroscopic structure is superimposed on the inner cone (37).

### STATE OF THE ART

The invention concerns a windshield wiper device as well as a wiper arm, in particular for a motor vehicle, in accordance with the species of the independent claims. Numerous windshield wiper devices are already known that have a wiper shaft, which is provided with a cone on which a wiper arm can be fastened. The wiper arms are provided with a matching inner cone in the area of their fastening to the cone, which is pressed on the cone of the wiper shaft of the windshield wiper device. To do this, a thread concludes the cone, on which a nut is screwed that presses the wiper arm on the cone.

Normally, the wiper arms in this fastening area are made of a casting material, e.g., aluminum or zinc diecasting. The cone is provided with knurling that embeds itself into the fastening part when pressing on the wiper arm and, due to the positive engagement that is created, increases the torque that can be transmitted from the wiper shaft to the wiper arm.

Increasingly, however, the fastening parts are fabricated of punched bent components made of steel sheeting, which has an essentially greater surface hardness than is the case with the fastening parts made of aluminum or zinc diecasting. So that the knurling of the cone must embed itself in the fastening part, essentially greater tightening torques are realized with the locking nut, which, in extreme cases, can lead to the thread of the wiper shaft tearing off during assembly.

### ADVANTAGES OF THE INVENTION

The windshield wiper device in accordance with the invention with the features of the main claim has the advantage that, due to a macroscopic structure that is superimposed on the cone, the force with which the cone of the wiper shaft is pressed into the wiper arm is increased with the same press-on pressure of the wiper arm on the wiper shaft. As a result, the knurls arranged on the cone can embed themselves better and deeper into the surface of the wiper arm, thereby reinforcing the connection between the wiper shaft and the wiper arm, and also enabling greater torques to be transmitted when using fastening parts with higher surface hardnesses.

Advantageous further developments and improvements of the features disclosed in the main claim are yielded by the measures listed in the sub-claims.

An especially great tilt stability of the connection is yielded if the center contact surface between the cone and the wiper arm is smaller than the effective surface shell of the cone.

This is achieved in the simplest possible manner if the cone features an undercut.

If the undercut is arranged on the circumference, this can be easily introduced into the wiper shaft when turning the cone without additional work steps being required. In addition, in this way the overall length of the cone is as equally large as without the undercut. This prevents a diminishing of the tilt stability of the wiper arm on the wiper shaft.

In one variation, the undercut can also be arranged in the axial direction, which further reduces tilt susceptibility and improves the alignment of the wiper arm. In addition, placement of the wiper arm on the cone is simpler in this way, since tilting of the inner cone is avoided.

The wiper arm in accordance with the invention with the features of claim 6 has the advantage that, due to a macroscopic structure which is superimposed on the inner cone of the fastening part, a greater torque can be transmitted from the wiper shaft to the wiper arm without the application force of the wiper arm on the cone having to be increased.

This shall be realized in a simple manner, in that the center contact surface between the inner cone and the cone of the wiper shaft is smaller than the effect surface shell of the inner cone.

This is achieved in the simplest possible manner if the cone features a relief groove.

Such a relief groove is particularly easy to manufacture, as it is arranged on the circumference.

If the relief groove is arranged in the axial direction, placement of the wiper arm on the wiper shaft is facilitated, since it cannot tilt. In addition, tilt susceptibility is further reduced. This is particularly the case if the number of axial relief grooves is uneven.

### DRAWINGS

Exemplary embodiments of the invention are depicted in the drawings and explained in greater detail in the following. They show:

FIG. 1 A perspective representation of a windshield wiper device in accordance with the invention.

FIG. 1a A schematic representation of a cone of the wiper shaft with a wiper arm in accordance with the state of the art.

FIG. 2 A side view of the cone of a wiper shaft of a windshield wiper device in accordance with the invention.

FIG. 3 A variation of the cone from FIG. 2.

FIG. 4a to 4c Various embodiments of the macroscopic structure of the cone from FIG. 3.

FIG. 5 Another variation of the cone from FIG. 2.

FIG. 6a to 6b Cross-sections of various embodiments of the macroscopic structure of the cone from FIG. 5.

FIG. 7 Another variation of the cone from FIG. 2.

FIG. 8 A cross-section through a cone from FIG. 7.

FIG. 9 A perspective representation of a wiper arm in accordance with the invention.

FIG. 10 A section through the fastening part of a wiper arm in accordance with the invention, with a relief groove with an expanded inner cone.

FIG. 10a A section through the fastening part of a wiper arm in accordance with the invention, with an relief groove with an inner cone formed by upsetting.

FIG. 11 A section through a variation of a wiper arm in accordance with the invention according to FIG. 10a.

FIG. 12a to 12c Various embodiments of the wiper arm in accordance with FIG. 11, with several relief grooves on the circumference.

FIG. 13 A section through a wiper arm in accordance with the invention with axial relief grooves.

FIG. 14 A section through the wiper arm from FIG. 13.

### DESCRIPTION OF THE EXEMPLARY EMBODIMENTS

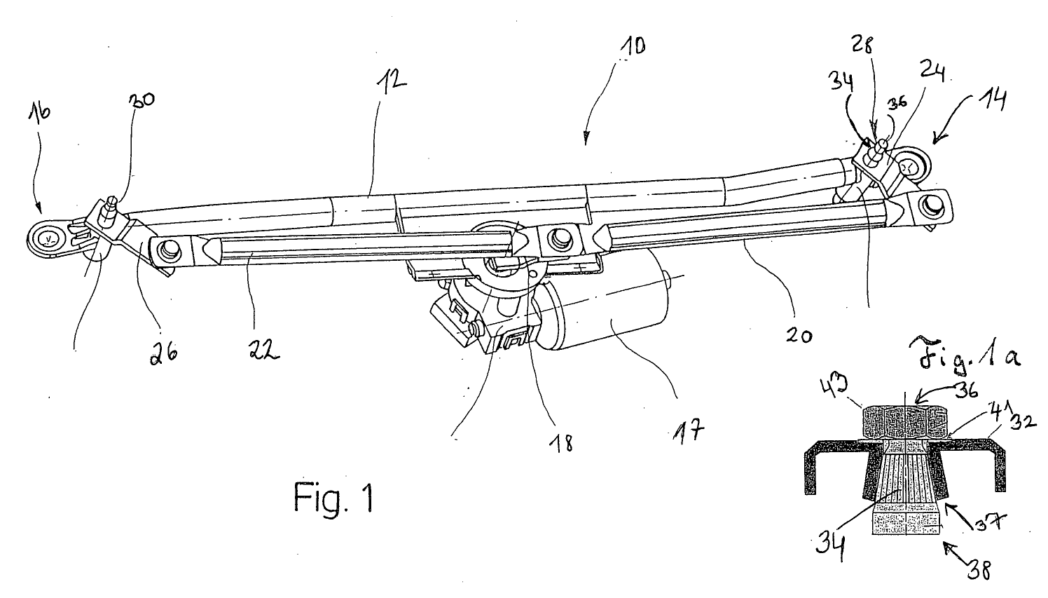

FIG. 1 shows a perspective representation of a windshield wiper device 10 in accordance with the invention. This includes a support tube 12 featuring two ends, on each of which a wiper bearing 14, 16 is attached. A wiper motor 16, which puts a crank 18 into either a back-and-forth or rotating motion, is arranged in the center of the longitudinal extension of the support tube 12 as a drive unit. The free end of the crank 18 is connected to two thrust rods 20, 22, which move driving cranks 24, 26, which drive the wiper shafts 28, 30. The wiper shafts 28, 30 are pivoted in the wiper bearings 14, 16 and in an assembled state accommodate wiper arms 32 (FIG. 9), on whose free ends wiper blades can be fastened. To fasten the wiper arm 32, the wiper shaft 28 features a cone 34, which is terminated by a cylindrical thread 36.

The connection of the wiper shaft 28 to the wiper arm 32 in accordance with the state of the art is shown in detail in cross-section in FIG. 1a. The cone 34 features knurling 35, which embeds itself in an inner cone 37 of the wiper arm 32. The knurling 35 is composed of small parallel notches, which feature a distance from one another of less than 0.5-1 mm, preferably less than 0.5 mm, in particular less than 0.3. The inner cone 37 of the wiper arm 32 touches the cone 34 in the area of its effective surface shell, which in this case extends around the cone 34 from the lower edge 39 of the inner cone 37 to the upper edge 41 of the inner cone 37. The center contact surface between the cone 34 and the wiper arm 32 is produced in the process by the effective surface shell of the cone 34, whereby the surface enlargement caused by the knurling 35 is left out of consideration. The inner cone 37 of the wiper arm 32 is pressed on the cone 34 by a nut 43, which is screwed on the thread 36.

FIG. 2 shows the end of the wiper shaft 28 of a windshield wiper device 10 in accordance with the invention on which the wiper arm 32 is fastened. In this case, the wiper shaft 28 features essentially three sections, a cylindrical first section 38, the cone 34 as the second section and the thread 36 as the third section. The cone 34 is provided with a circumferential undercut 40 as a macroscopic structure, whose width B is approximately half the height H of the cone 34. As a result, the effective surface shell of the cone 34, i.e., the area of the surface shell of the cone 34 in an assembled state in the inside of the inner cone 37, is greater than the center contact surface of the cone 34, i.e., greater than the contact surface that actually comes into contact with the cone 34 when placing the inner cone 37, whereby the surface change from the knurling 35 is left out of consideration. The macroscopic structure in this case is of a size that extends over several notches of the knurling 35.

Because of the reduction in the center contact surface of the cone 34, the force with which the cone 34 presses against the inner cone 37 is greater with a tightening torque of the nut 43 that remains the same. As a result, the knurling 35 can better embed itself in the inner cone 37, whereby the transmission of torque from the wiper shaft 28 to the wiper arm 32 increases.

In this connection, the undercut 40 is arranged approximately in the center of the longitudinal extension of the cone 34 so that the outer areas (in the axial direction) of the effective surface shell come into contact with the inner cone 37 of the wiper arm 32. Therefore, the entire height H of the cone 34 acts in a tilt-stabilizing manner, thereby preventing the wiper arm 32 from tilting.

FIG. 3 shows a variation of the wiper shaft 28 from FIG. 2. The cone 34 of the wiper shaft 28 in this case features several step-like undercuts 40 as a macroscopic structure. Teeth 42 are created by these undercuts 40, which when placing the inner cone 37 can embed themselves in said inner cone. In addition, every second undercut 40 is also provided with knurling 35 on an alternating basis.

FIGS. 4a through 4c show the undercuts 40 from FIG. 3 in detail. In FIG. 4a, the undercuts 40 are straight, i.e., only made axially so that the steps are embodied as concentric cylinders with the wiper shaft 28. In FIG. 4b, the steps are arranged in a tapered manner so that the teeth 42 feature a steeper tooth angle. The same applies to FIG. 4c, but the teeth are inclined in the opposite direction.

The undercuts from FIG. 4b and FIG. 4c must be processed using metal cutting due to their undercuts. In contrast to this, the undercuts 40 in FIG. 4a can be deformed, however, and require no additional metal-cutting processing. In this way, the steps 40 of the cone 34 can also be directly provided when the cone 34 is formed by upsetting.

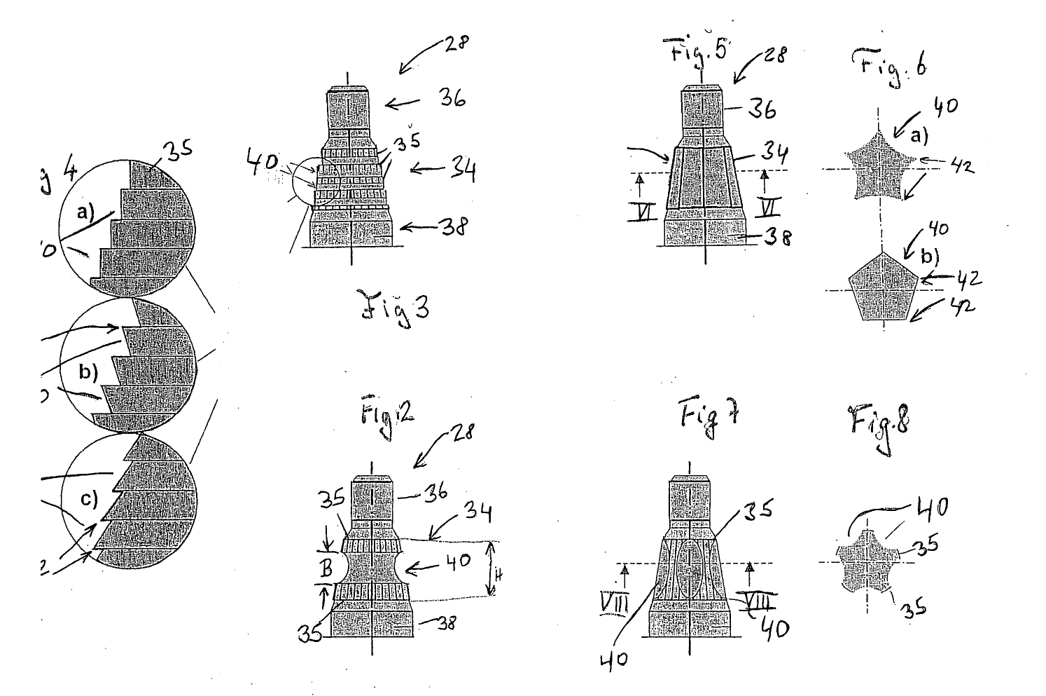

FIG. 5 shows another variation of the cone 34 from FIG. 2. The undercuts 40, as a macroscopic structure, are arranged in the axial direction in this case, however, and run essentially over the entire height H of the cone 34, which comes into contact with the inner cone 37.

FIG. 6 shows a cross-section through a cone in accordance with FIG. 5. Five radius-like undercuts 40 are provided, which are embodied in such a way that they touch and form teeth 42 on the contact lines, which are able to embed themselves into the inner cone 37. Naturally, the undercuts 40 can also be arranged separated from one another, i.e., not touching or only partially touching.

FIG. 6b shows a variation of the cross-section from FIG. 6a. In this case, the undercuts 40 are embodied to be even so that a pentagon is produced.

Of course, three, nine or more undercuts 40 can be provided. However, the number of undercuts 40 should be uneven in order to improve the tilt stability of the connection.

FIG. 7 shows another variation of the cone 34 from FIG. 2. The cone 34 is provided with knurling 35 in this case, which is broken up by elliptical indentations as undercuts 40. As a result of these types of elliptical undercuts 40, the center contact surface between the inner cone 37 and the cone 34 can be reduced in such a way that the knurling 35 embeds itself in the inner cone 37 in an improved way.

FIG. 8 depicts a cross-section through the cone from FIG. 7. The elliptical undercuts 40 break up the knurling 35 and thereby reduce the contact surface between the inner cone 37 and the cone 34.

FIG. 9 shows a schematic side view of a wiper arm in accordance with the invention. It is comprised of at least an articulated part 45, which is fastened to a fastening part 47 in a rotating manner. The fastening part 47 is manufactured in a punched bending process and on its end facing away from the articulated part 45 is the inner cone 37. This is used to fasten the wiper arm 32 to the wiper shaft 28.

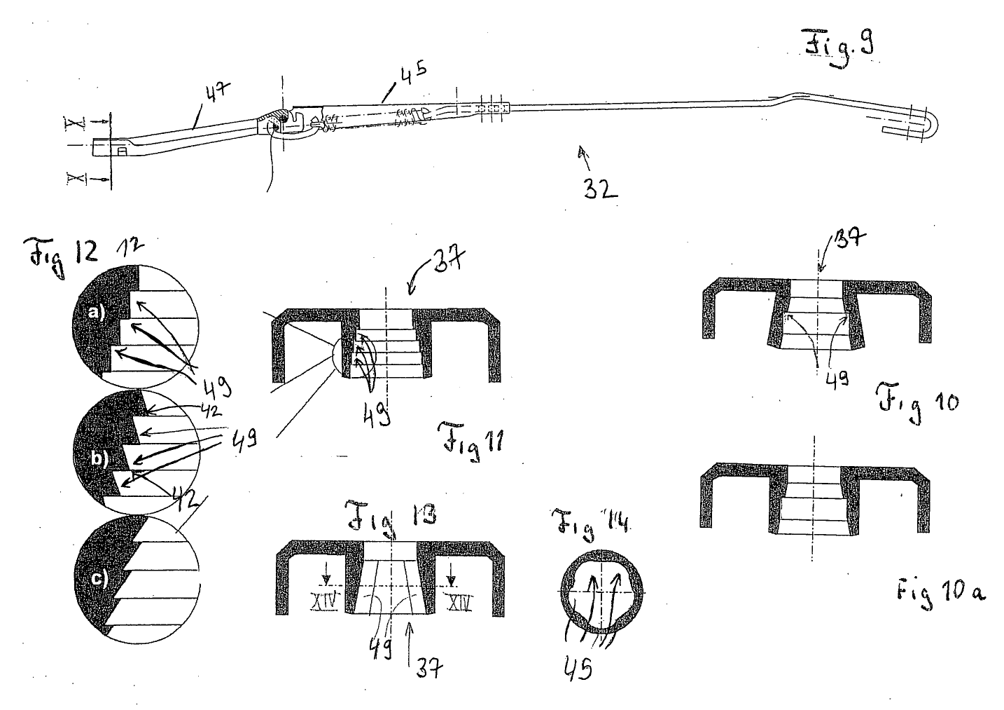

FIG. 10 shows a cross-section through a fastening part from FIG. 9 in the area of the inner cone 37. The inner cone 37 features a relief groove 49 so that the center contact surface between the cone 34 and the wiper shaft 28 and inner cone 37 of the fastening part 47 is reduced. The circumferential relief groove 49 is arranged in the axial direction approximately in the center of the inner cone 37 and embodied in such a way that the center contact surface of the cone 34 is reduced in relation to the effective surface shell of the cone 34, or the inner cone 37.

In this case, an expanded curvature of the steel sheet creates the inner cone 37. In the following figures, the inner cone 37 is formed by upsetting, however, so that the wall thickness on the side of the inner cone 37 that features the greater diameter is somewhat thinner than on the side that features the smaller diameter (FIG. 10a). These two variations are interchangeable, however.

FIG. 11 depicts a variation of the fastening part 47 from FIG. 10. The inner cone 37 features several relief grooves 49 in this case, whereby again here teeth 42 are created, which are able to embed themselves into the cone 34, or in the knurling 35 of the cone 34. The relief grooves 49 diminish again in the center contact surface of the cone 34 in relation to the effective surface shell of the cone 34, or the inner cone 37.

FIG. 12 depicts the relief grooves 49 in detail. In FIG. 12a, the relief grooves are straight, which can be created in manufacturing by simple forming by upsetting. FIGS. 12b and 12c show the relief grooves 49 in a variation of FIG. 12a provided with an undercut, whereby the tooth angle becomes steeper and the teeth 42 can better embed themselves in the cone 34 of the wiper shaft 28. FIG. 12c shows the same as in FIG. 12b, but in this case the undercuts and thus the teeth 42 are embodied in an opposite direction. Though this is more expensive to produce than the straight relief grooves 49 in FIG. 12a because a metal-cutting process is required, the connection between the wiper shaft 28 and the fastening part 47 is improved further, however.

FIG. 13 shows another variation of the fastening part 47 from FIG. 10. In this case, the relief grooves 49 are not circumferential, but arranged in the axial direction.

FIG. 14 shows a cross-section through the inner cone 37 of the wiper arm 32 from FIG. 13. The relief grooves 49 reduce the contact surface between the wiper shaft 28 and the inner cone 37 so that the knurling 35 of the cone is able to embed itself more strongly in the inner cone 37 of the fastening part 32.

1. Windshield wiper device (10), in particular for a motor vehicle, comprising at least a wiper shaft (28, 30) with a cone (34) on which a wiper arm (32) can be fastened, and knurling (35), characterized in that a macroscopic structure is superimposed on the cone (34).

2. Windshield wiper device (10) according to claim 1, characterized in that the center contact surface between the cone (34) and the wiper arm (32) is smaller than the effective surface shell of the cone (34).

3. Windshield wiper device (10) according to claim 1, characterized in that the cone (34) features at least one undercut (40).

4. Windshield wiper device (10) according to claim 3, characterized in that at least one undercut (40) is arranged on the circumference.

5. Windshield wiper device (10) according to claim 3, characterized in that at least one undercut (40) is arranged in the axial direction.

6. Wiper arm (32), in particular for a windshield wiper device (10) according to claim 1, comprised of a fastening part (47) with an inner cone (37), which can be fastened on a cone (34), characterized in that a macroscopic structure is superimposed on the inner cone (37).

7. Wiper arm (32) according to claim 6, characterized in that the center contact surface between the inner cone (37) and the cone (34) is smaller than the effective surface shell of the inner cone (37).

8. Wiper arm (32) according to claim 6, characterized in that the inner cone (37) features at least one relief groove (49).

9. Wiper arm (32) according to claim 8, characterized in that at least one relief groove (49) is arranged on the circumference.

10. Wiper arm (32) according to claim 8, characterized in that at least one relief groove (49) is arranged in the axial direction.

11. Windshield wiper device (10) according to claim 2, characterized in that the cone (34) features at least one undercut (40).

12. Windshield wiper device (10) according to claim 4, characterized in that at least one undercut (40) is arranged in the axial direction.

13. Wiper arm (32) according to claim 7, characterized in that the inner cone (34) features at least one relief groove (49).

14. Wiper arm (32) according to claim 9, characterized in that at least one relief groove (49) is arranged in the axial direction.

15. Wiper arm (32), in particular for a windshield wiper device (10) according to claim 2, comprised of a fastening part (47) with an inner cone (37), which can be fastened on a cone (34), characterized in that a macroscopic structure is superimposed on the inner cone (37).

16. Wiper arm (32), in particular for a windshield wiper device (10) according to claim 3, comprised of a fastening part (47) with an inner cone (37), which can be fastened on a cone (34), characterized in that a macroscopic structure is superimposed on the inner cone (37).

17. Wiper arm (32), in particular for a windshield wiper device (10) according to claim 4, comprised of a fastening part (47) with an inner cone (37), which can be fastened on a cone (34), characterized in that a macroscopic structure is superimposed on the inner cone (37).

18. Wiper arm (32), in particular for a windshield wiper device (10) according to claim 5, comprised of a fastening part (47) with an inner cone (37), which can be fastened on a cone (34), characterized in that a macroscopic structure is superimposed on the inner cone (37).
